(19) United States
(12) Patent Application Publication
(10) Pub. No.: US 2017/0150748 A9
(43) Pub. Date: Jun. 1, 2017

(54) DEVICE AND METHOD FOR PROCESSING LAYERED FOOD PRODUCTS

(71) Applicant: MAREL TOWNSEND FURTHER PROCESSING B.V., Boxmeer (NL)

(72) Inventors: Johannes Martinus MEULENDIJKS, Deurne (NL); Sigebertus Johannes Jacobus Jozef MEGGELAARS, Eindhoven (NL); Eric Henricus Johannes ABEN, Ledeacker (NL); Leon Marie Francois SPIERTS, Maastricht (NL)

(73) Assignee: MAREL TOWNSEND FURTHER PROCESSING B.V., Boxmeer (NL)

(21) Appl. No.: 14/764,897

(22) PCT Filed: Jan. 28, 2014
(86) PCT No.: PCT/NL2014/050042

§ 371 Date: Jul. 30, 2015

(30) Foreign Application Priority Data
Feb. 1, 2013 (NL) 2010230
May 2, 2013 (NL) 2010753

(51) Int. Cl. A23P 1/08

(52) U.S. Cl. CPC A23P 1/086

(57) ABSTRACT

The invention relates to a device for processing layered food products (40), comprising a conveyor (42) for transporting layered food products (40), and plural rollers (41) located above the conveyor (42) to contact the layered food products (40) transported on the conveyor (42). The invention also relates to a method for processing layered food products (40) lying on a conveyor (42) by subsequent groups of rollers (41) located above the conveyor (42).

The present invention relates to a device for processing layered food products that is provided with a conveyor for transporting the layered food products. The present invention also relates to a method for processing layered food products.

The market demands food products that are composed of at least two layers of food material that hold an intermediate layer as stuffing which intermediate layer is also made out of a food material but which food material is at least partially different from the external food material layers. The intermediate layer also does not have to match the at least two layers of (external) food material in size. Examples of such layered food products include a bottom layer and a top layer of joint meat parts (minced meat) with an intermediate filling that is retaining its form more or less or that alternatively may be viscous of liquid. An alternative for external meat layers is external dough layers. An example of a form retaining intermediate layer comprises for instance butter, cheese, egg, spices, meat mix, vegetables, meat or combination of these ingredients. More specific examples are minced meat cordon bleu (with a filling of ham and cheese), minced (chicken) meat chicken Kiev (with a filling of garlic butter and herbs) and various types of quiches. As an alternative the intermediate layer may also (partially) be made out of a viscous material as for instance peanut sauce (“satay”), barbeque sauce or any other type of sauce. It will be clear that also various other filled food (meat) products can be produced that meet the “recipe” of at least two layers of food material holding a stuffing of a different food material as an intermediate layer. During the preparation (frying, baking, cooking) of such layered food products it is to be prevented that due to melting a substantial part of the stuffing leaves the enclosure of the outside food material layers (the meat layers). It should also be prevented that due to evaporation part of the stuffing leaves the enclosure of the outside food material layers as steam and/or vapour. In practise the “envelope” of the semi manufacture of the stacked layers, that means the outside food material layers (the meat layers), is manually squeezed together to prevent (a substantial part of) the stuffing to pour out of or evaporate out of the assembled food product during the preparation process. Especially the circumference of the assembled food product is to be squeezed together as the leakage is likely to appear on the “weld” of the outside food material layers. By production of larger quantities of the layered food products the manual process of squeezing the circumference of the layered food products requires substantial labour, is also difficult to control and it is for hygienic reasons also less favourable.

A general object of the invention is to provide a device and a method for processing larger numbers of layered food products that result in enhanced production economy and that is better controllable both on product specifications to be realised as on the hygiene of the produced layered food products.

The present invention provides a device for processing layered food products, comprising: a conveyor for transporting layered food products, and plural rollers located above the conveyor to contact the layered food products transported on the conveyor, wherein the rollers are located in at least two groups: a first group of rollers arranged in parallel on a first shaft, which first shaft has a longitudinal axis which is parallel with a carrying surface of the conveyor and which longitudinal axis of the first shaft is also perpendicular to the transport direction of the conveyor, and a second group of rollers arranged in parallel on a second shaft, which longitudinal axis of the second shaft has a longitudinal axis which is parallel with the carrying surface of the conveyor and which second shaft is also perpendicular to the transport direction of the conveyor. As a conveyor or conveyor system use can be made of for instance one or more subsequent conveyor belts but also other types of conveyor systems may be applied such as for instance plate transporters. In case of using a conveyor belt the belt may be of a wire mesh type, a belt with apertures, or a closed band type. The layered food products laying on the conveyor are transported to the first group of rollers. The group of rollers arranged in parallel on a shaft can also be executed as a shaft with integrated rollers (so to say a pre-shaped shaft); such an embodiment is included in the wording “group of rollers arranged in parallel on a shaft”. The rollers may have any shape like wheels, disks, substantially (cylindrical) rollers, multi-zoned rollers and so on. Also the surface of the rollers may be provided of a surface relief that is adapted to the layered food products to be processed and the required specifications of the processed layered food products. As the distance of the rollers to the carrying surface of the conveyor is smaller than the thickness of the layered food product before processing the food product the first rollers are pressing on a part (two opposed strips) of the layered food products—in combination with the support of the conveyor—making that on opposite sides the food material layers are squeezed together. A stuffing concealed in between the two external food material layers can so be spared from (substantially) been pressed upon. After passing the first group of rollers the layered food products are not yet squeezed along the whole circumference; only on two opposite strips the layered food material is squeezed so to make the food material layers on those strips adhere together (or adhere better/stronger than before the pressure was exerted).

After passing the first group of rollers the layered food products are conveyed to the second group of rollers where again the distance of the rollers to the carrying surface of the conveyor is smaller than the thickness of the layered food product (at least at those locations where the layered food products were not already pressed upon with the first group of rollers). The second rollers exert a pressing force at least at that part of the circumference or the layered food products where they were not pressed upon already with the first group of rollers to close the envelope that is “made” from the layered food product so to enhance the capacity of the layered food product to hold a stuffing in between the layers.

One of the advantages of the device for processing layered food products according the present invention is that the circumference of the layered food product is squeezed together automatically. The replacement of the automatic handling of the layered food products is that such limits the labour demand and also enables a better and more hygienic process control. The squeezing of the circumference of the layered food product with at least two different groups of rollers (wheels) is that this enables to first squeeze together a part of the layers without substantially compressing a stuffing if such stuffing is not located (or only limited located) there where the pressure of the first group of rollers is exerted. After preparing a “dual guard” for the stuffing with the second pressure exerting the stuffing is this less likely to be squeezed outside the circumference of the layered food products. The rollers may rotate around the shaft they are mounted on so they can move along with the surface of the layered food product they are contacting; such rotating rollers may prevent that fluid stuffings are “squeeze out”. As an alternative also rollers that are fixedly mounted to a shaft may be applied.

At least a part of a surface of the rollers contacting the food products may be flexible. Especially, but not exclusively, a least a part of the contact surface of the rollers of the second group of rollers may be flexible as the choice can be to let the second rollers also pass the middle of the layered food product. A further advantage of at least partial flexible rollers is that the shape of the rollers can adapt to the edge of the layered food products and thus to realise an evenly processing of the circumference of the layered food products. Such at least partial flexible rollers may be realised when the rollers are inflatable like fully inflatable wheels or inflatable tyres mounted on inflexible rotatable wheels. A wheel can be split into at least two zones. Each of those zones can be inflated separately. Specific inflation pressure of such wheels can be between 1 and 10 Bar. However also alternatives for at least partial flexible wheels may be chosen as for instance wheels filled with a grained material of rollers at least partially made out of elastic material. A further alternative is to provide the rollers with plural zones that could have different heights and/or different flexibility.

As to limit the pressure level to be exerted on the middle of the layered food products,—and thus to a stuffing that may advantageously be located in the middle—the conveyer may be provided with holders for at least partially holding—especially for holding the middle—of the layered food products. For example these holders may be executed as indentations in the carrying surface or protrusions from the carrying surface. Alternatively or in combination the conveyor may also be provided with protrusions for holding the food products.

As to realise that the second rollers process the layered food products on different locations than the first group of rollers, the second group of rollers is located shifted in relation to the first group of rollers such that at least one of the second rollers in the transport direction of the conveyor is located in between two rollers of the first group of rollers. Such functionality can be realised when the first group of rollers is arranged on the first shaft with identical mutual distances, and the second group of rollers is arranged on the second shaft with identical mutual distances. The second rollers may be fed over the layered food products over the whole area where they were not already pressed upon by the first group of rollers. In such a situation the processing direction on the layered food products with both groups of wheels is identical. The interspace between the rollers on the different shafts may vary and to control the position of the rollers on the shafts one or more of the shafts may be preformed to provide “seats” for the rollers on the shaft(s). To prevent the second group of rollers to exert to much pressure on the centre of the layered food products the choice may be to make the distance of the rollers of the first group of rollers to the carrying surface of the conveyor smaller than the distance of the rollers of the second group of rollers to the carrying surface of the conveyor. A further choice may be to make the flexibility of the rollers of the first group of rollers lower than the flexibility of the rollers of the second group of rollers.

A further alternative is to provide the food processing device between the first group of rollers and the second group of rollers with a turning mechanism to rotate the layered food products on the conveyor or to place them in a rotated situation on a subsequent conveyor. In such situation and with the second group of rollers is located in the transport direction of the conveyor in line with the rollers of the first group of rollers the layered food products can now be pressed upon with the second group of rollers—in line with the pressure pattern as exerted by the first group of wheels—on opposed strip like areas of the layered food products. This enables to exert pressure on the entire circumference of the layered food products in two steps (by the first group of rollers and the second group of rollers) without the need of exerting any pressure on the centre of the layered food product.

For a self-steering production process the at least one of the rollers may be self-centering.

To prevent the layered food products to stick on the rollers the food processing device may be provided with a least one fluid dispenser to moisten at least a part of the outer surface of one of the rollers, as such fluid dispensing may limit the adhesion of the rollers to the layered food products. Dependent on the production circumstance it may also be advantageous to provide the food processing device with at least one dryer for drying at least a part of the outer surface of one of the rollers. Fluid dispensing may also be provided before the food product contacts the rollers as to limit the adhesion between the food products and the rollers. As a further alternative spraying may be applied to at least one of the outer food layers before they are brought in contact with each other as to enhance the sticking of the outer food layers together there where they make contact.

Additionally the food processing device may also be provided with a coating unit for coating the layered food products. Especially for the production of recipes like chicken Kiev when a coating to the food products is required it is efficient to combine the automatic application of a coating with the automatic pressure exerting to the circumference of the layered food products.

The invention also provides a method for processing layered food products, comprising the processing steps: A) feeding layered food products lying on a conveyor (system) to a first group of rollers located above the conveyor, B) exerting pressure with the first group of rollers located above the conveyor on opposite sides of the layered food products lying on the conveyor so to compress the layered food products on opposite strips for locally joining layers of the layered food products, and C) feeding the over opposite strips compressed layered food products with the conveyor to a second group of rollers located above the conveyor to compress a least partially the non-compressed part of the layered food products so that the layered food products are compressed at least along their entire circumference. For the advantages of the method for processing layered food products reference is made to the advantages already mentioned in relation to the device for processing layered food according the present invention and are here also brought forward in relation to the method by reference. As to further limit the chance of any liquid stuffing flowing beyond the circumference of the layered food product the lower external food layer may be chosen to be tray shaped, so be shaped as a layer with protruding edges to even better hold the stuffing and to further limit the pressure to be exerted on the stuffing. Furthermore the present invention enables also the processing of layered food products with more then two layers with an intermediate stuffing; for instance two layers with an intermediate multiple layered stuffing may be process. Apart from the ingredients that form the stuffing during one of the processing steps also other ingredients may be added such as for instance a material that is added to enhance the binding of the layers of the layered food products (e.g. a food grade glue layer). As an alternative it maybe clear that also other alternatives of multi-layered food products may be processed according the present invention.

In an embodiment of the method during processing step C) a substantial part the surface area of the layered food products between the during processing step B) compressed strips of the layered food products is compressed. Such compression of the area between the strips of the food product that have been compressed already in an earlier stage (e.g. the entire area) is an option when the direction of the compression wheel in the first and the second compression step is identical.

A further option is to perform the compression during processing step B) and/or C) with rollers of which at least a part of a surface of the rollers contacting the food products is flexible. Use of at least partial flexible rollers prevents the pressure to be exerted on the central part of the layered food product to exceed a specific pressure value. Additionally, or as an alternative, the conveyer may be provided so to provide the central part of the layered food product more space when passing the second rollers and thus provides a yet another option to prevent the pressure to be exerted on the central part of the layered food product to exceed a specific pressure value.

As an alternative for the direction of the compression wheel in the first and the second compression step being identical it is also possible to rotate the over opposite strips compressed layered food products on the conveyor after the processing step B) and before the processing step C). Such rotation may be a rotation in the plane of the conveyor over 90° but also other rotations are possible as well as that—plural rotation steps maybe applied. An advantage of rotating the food products between the first en second compression steps is that this enables to compress the complete circumference of a layered food product without a required compression of the centre part of the layered food product. The rotated and over opposite strips compressed layered food products may then be compressed during processing step C) on opposite strips. So during processing step C) also opposite for locally joining layers of the layered food products and thus the central part of the layered food product can be prevented of being exerted compression upon. The compression may also be combined with heating to compressed strips as to “seal” the outer food layers together. For such processing e.g. relative thin heated rollers can be used that seal the product layers of the layered food product locally together. The sealing can be effected by local denaturing of protein. Another alternative is to make use of a wider roller with only a part or segment of the roller being heated (e.g. an heated outer rim or a heated central rim). A further alternative in this respect is to partially heat the rollers from the first and/or second group of rollers to introduce one or more local markings in the layered food products, for instance a grill marking or any other type of heat initiated marking. A further option is to provide the conveyor for transporting the layered food products with marking means like local heating means and/or a profile to introduce a specific print in to the side of the layered food product that is in contact with the layered food products. This can be realised by parts or segments of one or more of the roller being heated such that when these heated roller surface parts contact the layered food products a heat imprint results in the layered food product.

Forming a bottom layer and a top layer of the layered food products from joint meat parts has the advantage that the shape of the bottom layer and a top layer can simply be controlled. When before the external (outer) individual food layers that are stacked to form the layered food product over at least a part of their circumference are provided of a surface roughness this could enhance the adhesion of the outer layers. A further advantage is that the surface roughness could further enhance the sealing capacities of the final “envelope”. The chance that any stuffing (or gasses from the stuffing) leaves the envelope at a undesired moment can be further limit with the surface roughness.

The present invention is further elucidated on the basis of the non-limitative exemplary embodiment shown in the following figures. Herein:

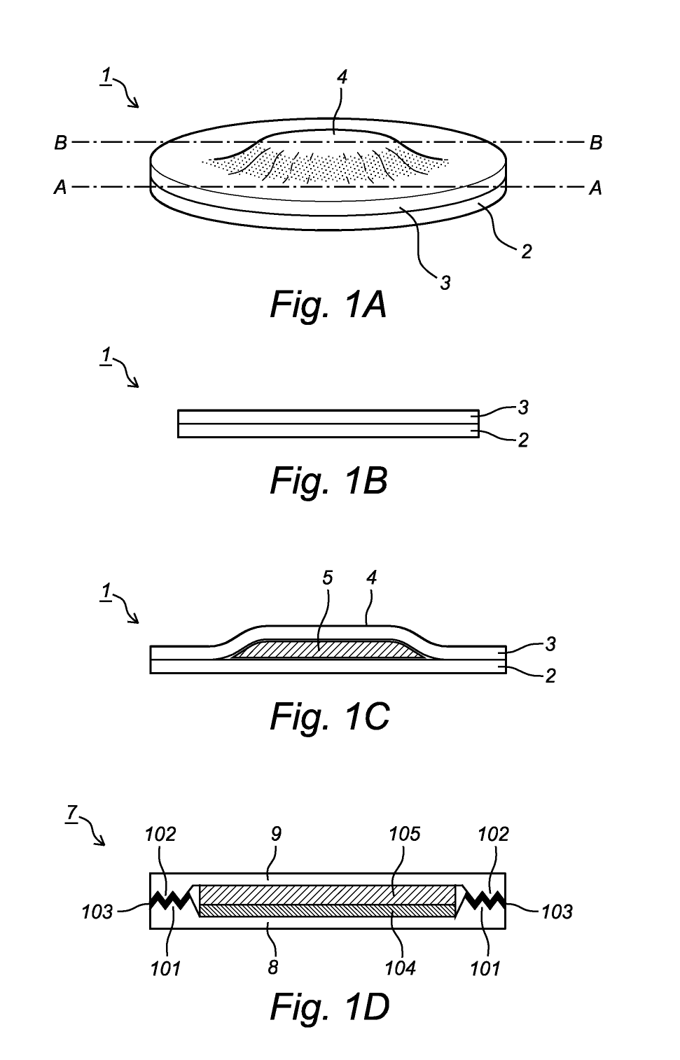

FIGS. 1A-1D show various views on layered food products to be processed according the present invention in different stages of processing,

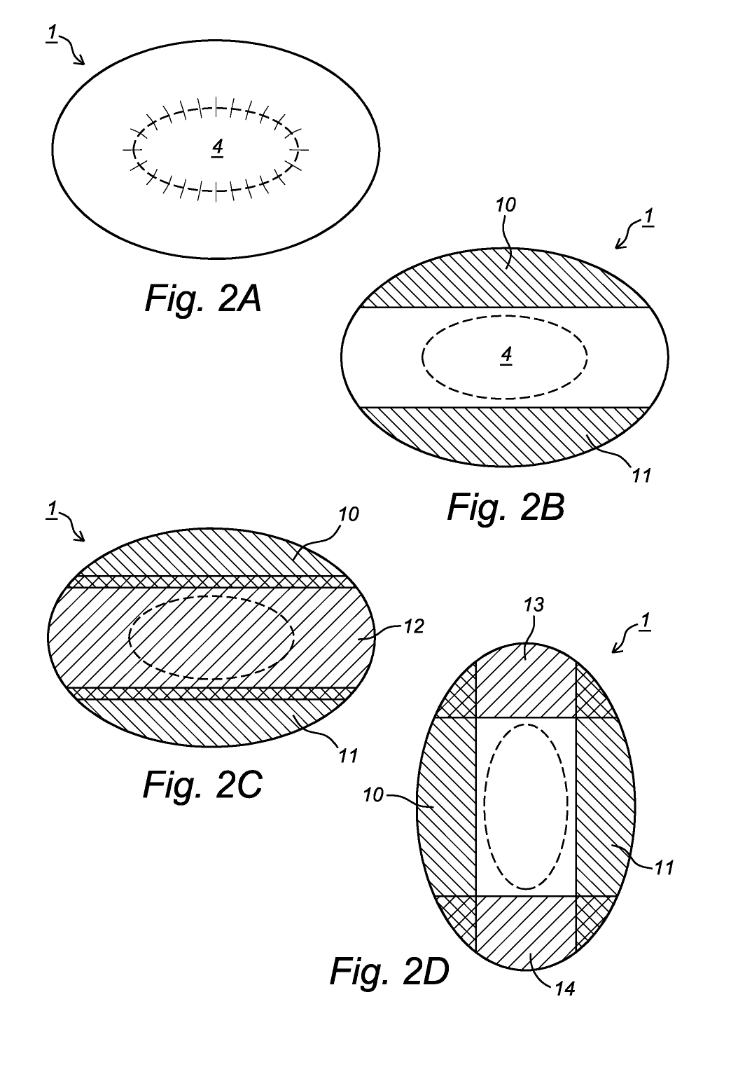

FIGS. 2A-2D show various top-views on various stages of processing of a layered food product according the present invention,

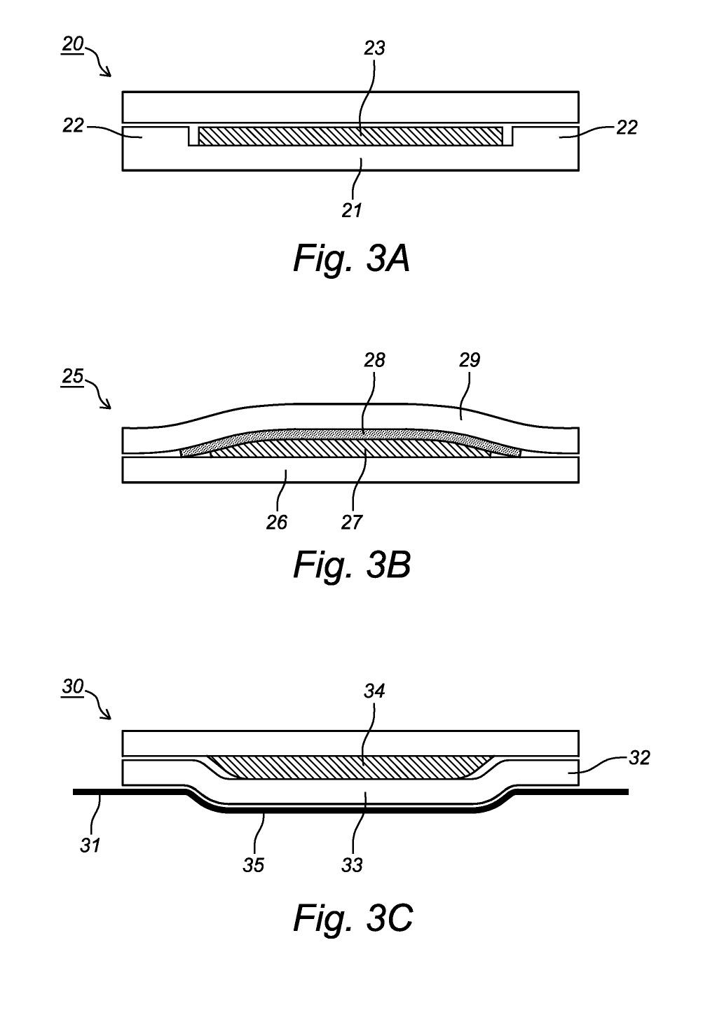

FIGS. 3A-3C show cross-sections through various types of non processed layered food product to be processed according the present invention,

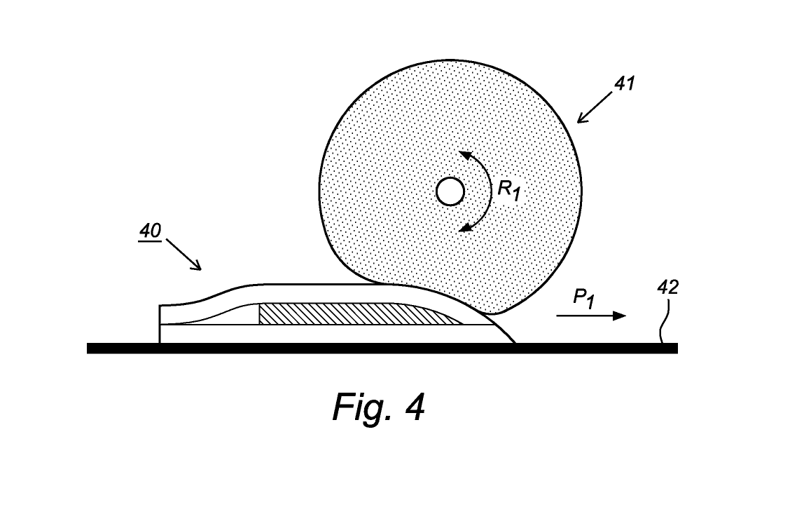

FIG. 4 shows a schematic view of a processing step of a layered food product according the present invention,

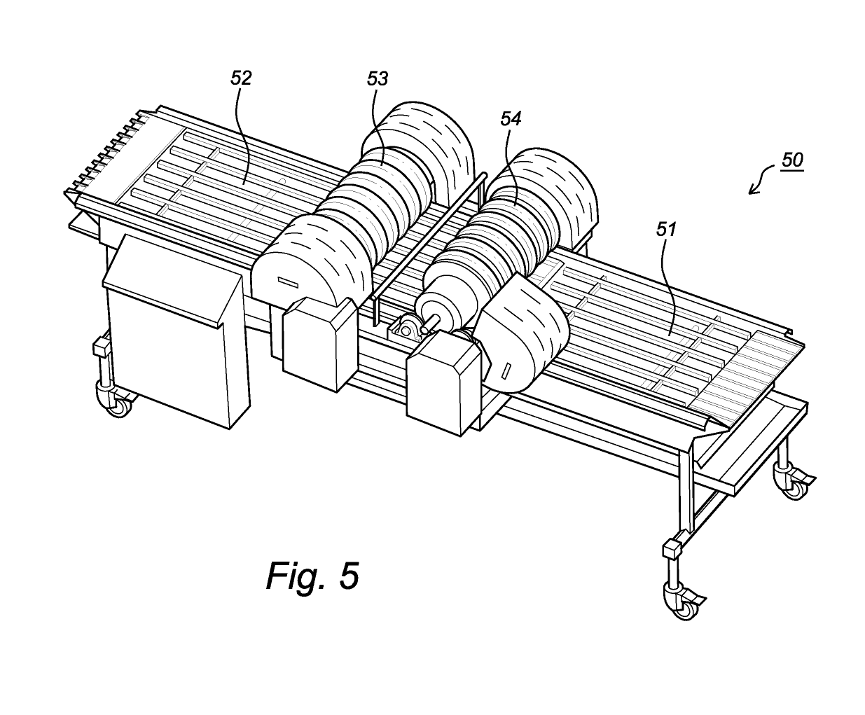

FIG. 5 shows a perspective views on a device for processing layered food products according the present invention, and

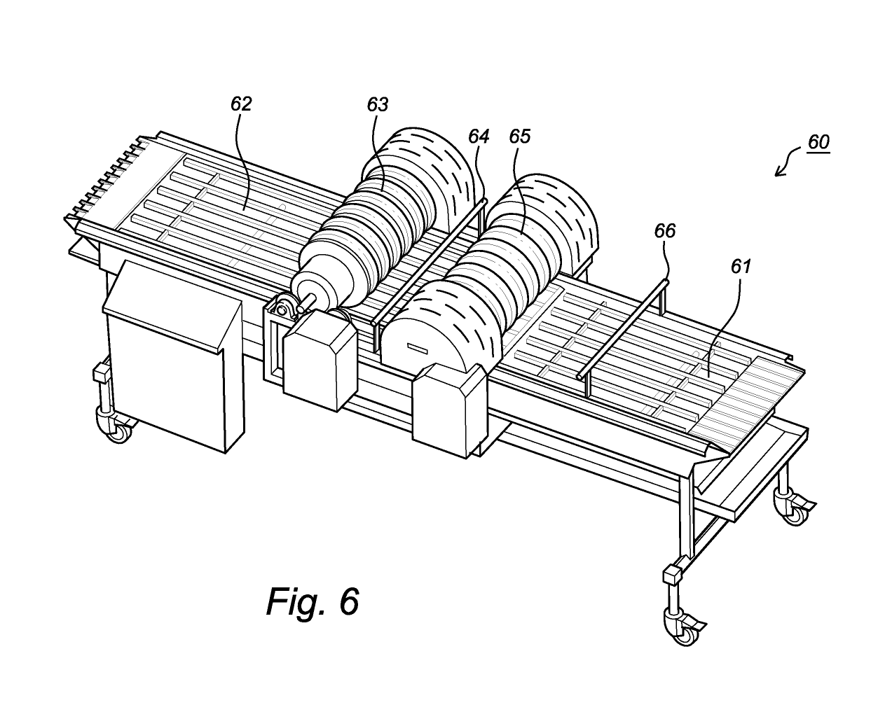

FIG. 6 shows a perspective views on an alternative device for processing layered food products according the present invention.

FIG. 1A shows a perspective view on a non-processed layered food product 1 to be processed according the present invention. The layered food product 1 includes a bottom layer 2, e.g. a meat layer, and a top layer 3, e.g. also a meat layer. In between the bottom layer 2 and the top layer 3 an intermediate lager as filling or stuffing is positioned, however this intermediate layer is not visible in this perspective view. Visible however is an elevation 4 in the top layer 3 indicating the position of where the intermediate layer (filling/stuffing) is located. The top layer 3 and the bottom layer 2 of the layered food product 1 may typically be assembled of joint meat parts (for instance minced meat).

In FIG. 1B a cross section over the line A-A of the layered food product 1 as shown in FIG. 1A is shown and in FIG. 1C a cross section over the line B-B of the layered food product 1 as shown in FIG. 1A is shown. In both the FIGS. 1B and 1C the bottom layer 2 and the top layer 3 are indicated. In FIG. 1C also intermediate layer 5 is visible with causes the elevation 4 in the top layer 3.

When preparing the layered food product 1 the intermediate layer 5 may respond different to the preparation process (frying, baking, cooking, heating) than the bottom layer 2 and the top layer 3 with for instance the undesired result that (part of) the intermediate layer 5 (stuffing) flows out of the envelope shaped by the bottom layer 2 and the top layer 3. To enhance the retaining capacity of the envelope shaped by the bottom layer 2 and the top layer 3 the demand is to compress the circumference of the envelope shaped by the bottom layer 2 and the top layer 3 so to enhance the fixation of the envelope shaped by the bottom layer 2 and the top layer 3 along the contour (perimeter) of the layered food product 1. Before bringing the bottom layer 2 and the top layer 3 together it is also possible to provide a contacting rim of one or both the layers 2, 3 from a profiled contact surface as to enhance the fixation of the layers 2,3 there where they contact. The shape of the layered food product 1 as illustrated is oval however all types of different shapes are also possible within the scope of protection of the present application. Some—non-limitative—examples of alternative shapes are circular, square, rectangular, any other polygon shape (with 4 or 6 or any other number of corners), D-shape (e.g. for cordon blue), cylinder shape (e.g. for corndogs) and so on.

FIG. 1D show a cross section trough a layered food product 7 with a bottom layer 8, and a top layer 9. Both the external layers 8, 9 a provided with a profiled (dented) perimeter 101, 102 to improve the attachment of the external layers 8, 9. To enhance the attachment of the external layers 8, 9 even further between the profiled perimeters 101, 102 a food grade “glue” layer 103 is provide as well. The glue layer 103 can for example be made of (sticky) cheese or any other type of food type having “glue properties”. Also alternative ingredients or stuffings may be applied to the profiled (dented) perimeter 101, 102 before the layers are piled up. In between the external layers 8, 9 a double layered stuffing 104, 105 is placed. As a further alternative also the complete internal surfaces of the external layers 8, 9 may be provided of a profiled (dented) surface.

In FIG. 2A a top view of a layered food product 1 as depicted in FIGS. 1A-1C is shown. With a first compression step according the present invention on two strips of the layered food product 1 pressure may be exerted. In FIG. 2B the two areas 10, 11 where the pressure is exerted on are shaded represented. In a subsequent compression step pressure may also be exerted on a central area 12 (see the additional shaded area in FIG. 2C). To make sure that the complete circumference of the layered food product 1 is compressed the subsequently compressed area 12 may overlap the two compressed strip like areas 10, 11.

In an alternative production method after first compression of the two strips 10, 11 of the layered food product 1 in a subsequent compression step again two strip like areas may be compressed but the subsequent compressed strip like areas 13, 14 as depicted in FIG. 2D are subsequently introduced in a direction perpendicular to the two strips 10, 11 as introduced with the first compression. This may be executed by turning the layered food product 1 in between the two compression steps or, alternatively, by applying the pressure with pressure wheels that vary in their mutual position. A clear advantage of the pressure being exerted in the pattern as shown in FIG. 2D is that the layer of intermediate food material 5 (there where the elevation 4 is located) is not pressed upon.

In FIG. 3A a cross section of a layered food product 20 is shown wherein a lower food material layer 21 is provided with a protruding circumferential part 22 so that the lower food material layer 21 is tray shaped. The advantage of such tray shaped lower food material layer 21 is that the intermediate material layer can even be better prevented of being exerted pressure upon. Further advantages are that the tray shaped lower food material layer 21 enables easy positioning of the intermediate material layer 23 relative to the tray shaped lower food material layer 21 and that the chance that any liquid or liquefied intermediate food material 23 (the intermediate food material can for instance change to a viscous mass as an effect of heating the intermediate food material) flows out of the layered food product 20. Different form the embodiment shown in this figure it is also possible to provide the upper material layer from a protruding part and so to enhance the volume of the remaining aperture to hold the intermediate food material 23. As an alternative for the embodiment shown in this FIG. 3A also a double trays shaped construction may be applied, so a tray shaped lower food material layer 21 in combination with an upper food layer that is also tray shaped.

In FIG. 3B a cross section of a further alternative layered food product 25 is shown wherein on a lower food material layer 26 two different intermediate food material layers 27, 28 are positioned, An example of such layered food product 25 is for instance a chicken cordon bleu, comprising two external layers 26, 29 of minced chicken meat holding a cheese layer 27 and a ham layer 28.

In FIG. 3C a cross section of a layered food product 30 is shown including a part of a conveyor belt 31 carrying the layered food product 30. A lower food material layer 32 is provided with a downward protruding part 33 (the opposite of the elevation 4 as shown in FIG. 1C) there were the intermediate material layer 34 of the layered food product 30 is located. The conveyor belt 31 enables such downwards protruding part 33 as the belt 31 is for this purpose provided with a cut out part 35. The remark is made here that in practise the belt 31 is provided with a plurality of cut out parts 35 to make it possible to transport a plurality of layered food product 30 at the same time with the conveyor belt 31. Such construction of the conveyor belt 31 also prevents the intermediate material layer of being exerted pressure upon, enables easy positioning of the intermediate material layer 34 relative to the lower food material layer 32 and limits the chance of liquid or liquefied intermediate food material 34 flows out of the layered food product 30. The conveyor belt 31 can be provided of a Teflon contact surface, among others to minimise the contamination of the contact surface and to minimise sticking of the layered product 30 to the contact surface of the conveyor belt 31.

FIG. 4 shows a schematic view of a processing step of a layered food product 40 being exerting pressure upon with a roller 41, which is located above a conveyor belt 42. When contacting the layered food product 40 the roller 41 transforms due to the flexibility of the roller 41. The shape of the roller 41 can thus adapt to shape of the layered food product 40 so extremities in the pressure exerted on the layered food product 40 can be prevented. The roller 41 may a gas inflated wheel, a liquid filled wheel, a wheel with a grained filling (like dry beans) and/or the roller may at least partially be made out of an elastic material.

As for the direction of rotation of the roller 41 the choice can be made to make the direction of rotation (see arrow R₁) so that there where the roller 41 and the layered food product 40 make contact the movement of the roller surface is in the same direction as the forward transport movement (see arrow P₁) of the layered food product 40. Alternatively the direction of rotation of the roller 41 may also be chosen in the other direction of rotation or the choice may be to make the roller being in a stationary position. The have an impact on the remaining shape of the processed layered food product the roller 41 and/or the conveyor belt 42 may further more be provided with a profile (e.g. to get a layered food product with a circumference that shows markings like fork prints). A further alternative is that the device for processing layered food products is also provided with a stamp to further influence the shape of the processed layered food product.

FIG. 5 shows a perspective view on a device 50 for processing layered food products according the present invention with a frame 51 carrying a conveyor 52 for transporting the layered food products. When transported on the conveyor 52 the layered food products will contact a first row of plural rollers 53 located above the conveyor 52. After passing the first row of plural rollers 53 the layered food products will contact a second row of plural rollers 54. For a processing of the layered food product in line with the processing as explained in relation to FIG. 2C the rollers 53 of the first row are off set compared to the rollers 54 of the second row. This figure also shows the rollers 53, 54 as inflated wheels being flexible when contacting the layered food products.

FIG. 6 shows a perspective view on an alternative device 60 for processing layered food products according the present invention again with a frame 61 carrying a conveyor 62 for transporting the layered food products. Also here when transported on the conveyor 62 the layered food products will contact a first row of plural rollers 63 located above the conveyor 62. Different compared to FIG. 5 is that here after passing the first row of plural rollers 63 the layered food products are rotated by a turner 64 around an axis that is perpendicular to the carrying surface of the conveyor 62. After rotation (preferably a rotation over 90°) the layered food products will contact a second row of plural rollers 65. The turning of the layered food products in between the rollers 63 and the rollers 65 enables a processing of the layered food product in line with the processing as explained in relation to FIG. 2D. After the second row of plural rollers 65 a subsequent spray bar 66 is placed for adding a (finishing) food grade material layer to the multi-layered products. Dependent on the required specifications of the processed layered food products a spray bar 66 may also be placed before the first row of plural rollers 63 and/or between the first row of plural rollers 63 and the second row of plural rollers 65.

1. Device for processing layered food products, comprising
a conveyor for transporting layered food products, and
plural rollers located above the conveyor to contact the layered food products transported on the conveyor,
wherein the rollers are located in at least two groups:
a first group of rollers arranged in parallel on a first shaft, which first shaft has a longitudinal axis which is parallel with a carrying surface of the conveyor and which longitudinal axis of the first shaft is also perpendicular to the transport direction of the conveyor, and
a second group of rollers arranged in parallel on a second shaft, which second shaft has a longitudinal axis which is parallel with the carrying surface of the conveyor and which longitudinal axis of the second shaft is also perpendicular to the transport direction of the conveyor.

2. Food processing device according to claim 1, characterised in that at least a part of a surface of the rollers contacting the food products is flexible.

3. Food processing device according to claim 1, characterised in that the rollers are inflatable wheels.

4. Food processing device according to claim 1, characterised in that the conveyer is provided with holders for at least partially holding the layered food products, for example indentations in the carrying surface and/or protrusions from the carrying surface.

5. Food processing device according to claim 1, characterised in that the second group of rollers is located shifted in relation to the first group of rollers such that at least one of the second rollers in the transport direction of the conveyor is located in between two rollers of the first group of rollers.

6. Food processing device according to claim 5, characterised in that the distance of the rollers of the first group of rollers to the carrying surface of the conveyor is smaller than the distance of the rollers of the second group of rollers to the carrying surface of the conveyor.

7. Food processing device according to claim 5, characterised in that the flexibility of the rollers of the first group of rollers is lower than the flexibility of the rollers of the second group of rollers.

8. Food processing device according to claim 1, characterised in that between the first group of rollers and the second group of rollers the food processing device is provided with a turning mechanism to rotate the layered food products on the conveyor.

9. Food processing device according to claim 8, characterised in that the second group of rollers is located in the transport direction of the conveyor in line with the rollers of the first group of rollers.

10. Food processing device according to claim 1, characterised in that at least one of the rollers is self-centering.

11. Food processing device according to claim 1, characterised in that the food processing device is provided with a least one fluid dispenser to moisten at least a part of the outer surface of one of the rollers.

12. Food processing device according to claim 1, characterised in that the food processing device is provided with at least one dryer for drying at least a part of the outer surface of one of the rollers.

13. Food processing device according to claim 1, characterised in that the food processing device is provided with a coating unit for coating the layered food products.

14. Method for processing layered food products, comprising the processing steps:
A) feeding layered food products lying on a conveyor to a first group of rollers located above the conveyor,
B) exerting pressure with the first group of rollers located above the conveyor on opposite sides of the layered food products lying on the conveyor so to compress the layered food products on opposite strips for locally joining layers of the layered food products, and
C) feeding the over opposite strips compressed layered food products with the conveyor to a second group of rollers located above the conveyor to compress a least partially the non-compressed part of the layered food products so that the layered food products are compressed at least along their entire circumference.

15. Method according to claim 14, characterised in that during processing step C) at least a substantial part of the area of the layered food products between the during processing step B) compressed strips of the layered food products is compressed.

16. Method according to claim 15, characterised in that the compression during processing step B) and/or C) is performed with at least partially flexible rollers.

17. Method according to claim 14, characterised in that after the processing step B) and before the processing step C) the over opposite strips compressed layered food products are rotated on the conveyor.

18. Method according to claim 17, characterised in that the rotated over opposite strips compressed layered food products are compressed during processing step C) on opposite strips.

19. Method according to claim 14, characterised in that a bottom layer and a top layer of the layered food products are formed from joint meat parts.

20. Method according to claim 14, characterised in that before individual food layers are stacked to form the layered food product at least a part of the of the circumference of at least one of the outer food layers is provided of a surface roughness.
